(19) United States
(12) Patent Application Publication
(10) Pub. No.: US 2008/0251183 A1
(43) Pub. Date: Oct. 16, 2008

(54) Apparatus and method of fabricating a door

(76) Inventor: Daniel S. Turner, Poland, OH (US)

Correspondence Address: SIMPSON & SIMPSON, PLLC, 5555 MAIN STREET, WILLIAMSVILLE, NY, 14221-5406, US

(21) Appl. No.: 11/786,919

(22) Filed: Apr. 13, 2007

(51) Int. Cl. B32B 15/04

(52) U.S. Cl. 156/79; 52/656.5

(57) ABSTRACT

An insert for fabrication of a door light in a door, the door includes a pair of interlocking and oppositely disposed door skins forming a cavity therebetween, each door skin includes a door light opening, the door light opening in each respective door skin is registerably aligned with the opposing door skin, the insert includes a pair of engagement flanges for engagement with the door skins within the cavity, the insert is engageable within the door light opening of each door skin to close the cavity between the door skins to prevent an infill of a foam into the door light opening during fabrication. A method for fabricating a door having a window including the steps of positioning a first door skin on a first press, positioning an insert in aligned registration with a first door light opening of the first door skin, positioning a second door skin over the insert, wherein the second door light opening is in aligned registration with the insert and the first door skin, applying pressure with the first press to secure the first and second door skins with the insert and injecting a foam into a first cavity formed between the first and second door skins and insert.

### FIELD OF THE INVENTION

The invention broadly relates to doors, more specifically to lights for doors, and even more particularly to lights for doors constructed from complimentary door skins. The invention also broadly relates to a method of fabricating a door with a door light formed within door skins before assembly to accommodate a window. The invention also relates to an apparatus for carrying out the method of fabrication.

### BACKGROUND OF THE INVENTION

Typically, doors constructed of steel or fiberglass comprise two molded door skins forming the front and back surfaces of the door. The door skins are joined together and filled with an expanding foam core which provides insulation, e.g., thermal and sound, and increases structural integrity. Reinforcing and mounting strips, made typically of wood, are sometimes used to provide additional structural and internal integrity when needed.

Each door skin generally has rolled edges to define a perimeter edge used to secure the door skins together when assembled. The door skins are aligned and positioned within a press which forces the perimeter edges together and locks them in place. After the door skins are secured together, synthetic insulation foam is injected between the skins filling the cavity formed therebetween.

For example, contemporary metallic doors are constructed of thin metallic door skins that comprise the exterior of the door. Door skins are formed from hot dipped galvanized deep drawn steel that is stamped into a desired door shape. The door skins form the exterior of the door and can be joined at the perimeter of the skins by flanges, as previously described, or the door skins can be joined to a frame, e.g., a wood frame, between the skins. Subsequently, a foam core is used to fill the internal cavity left between the door skins, as described supra.

If the door is intended to have a window opening, commonly known to those of ordinary skill in the art as a door light, an additional fabrication step is required. The opening must be cut out to remove the respective door skin areas, and includes the foam core therebetween. The cut out subsequently becomes a waste product that must be disposed of as there is no further use that can be made of the cut out.

Although the finished door does not include the above described waste material, the finished door cost does include the cost of these materials. Thus, end users must pay more for a door having less material, i.e., after the window opening is formed. In some instances, manufacturers of finished doors cut the window opening in their facility as opposed to having the raw door manufacturer perform this operation. Thus, an uncut door which includes all the additional waste material must be shipped to the finishing manufacturer. The uncut doors weigh more than cut doors and therefore shipping costs are also increased thereby raising the final cost to an end user.

As can be derived from the variety of devices and methods directed at forming doors and in particular forming doors having a light, many means have been contemplated to accomplish the desired end, i.e., constructing a low cost, high quality door with at least one light. Heretofore, tradeoffs between material waste generated during manufacture and cost were required. Thus, there is a long-felt need for a door constructed from door skins having a door light installed therein prior to filling the door with insulating foam. There is a further long-felt need for a door having a door light and a reduced overall weight. There is also a long-felt need for a door having a door light which generates a reduced amount of waste during assembly.

### BRIEF SUMMARY OF THE INVENTION

The present invention broadly comprises a method for fabricating a door having a window, the door includes first and second door skins having first and second door light openings, respectively, the method includes the steps of: a) positioning the first door skin on a press; b) positioning an insert in aligned registration with the first door light opening of the first door skin; c) positioning the second door skin over the insert, wherein the second door light opening is in aligned registration with the insert and the first door skin; d) applying pressure with the press to secure the first and second door skins with the insert; and, e) injecting a foam into a first cavity formed between the first and second door skins and insert. In some embodiments, the method further includes the step of: f) inserting the window within a second cavity formed by the insert. In other embodiments, the insert includes a pair of engagement flanges for aligned registration and engagement with the first and second door skins, while in yet other embodiments, the insert further includes a secondary pair of flanges positioned substantially parallel and between the pair of engagement flanges, the secondary pair of flanges are encapsulated by the foam within the cavity during the injection step. In still further embodiments, the secondary flanges are equal in length but shorter in length than either of the engagement flanges. In some embodiments, each of the pair of engagement flanges includes an offset engagement surface so that outer interfaces between respective first and second door skins and the insert are substantially flush.

In other embodiments, the insert is a molded plastic article. In still further embodiments, the insert is a metal article formed by a second press, the insert includes first and second bent portions, and in some of these embodiments, the first and second door skins include first and second beads, respectively, arranged proximate the first and second door light openings, respectively, and the first and second bent portions of the insert are operatively arranged to matingly engage the first and second beads, respectively. And in still further embodiments, the present invention broadly comprises a door fabricated according to the above described method.

The present invention also broadly comprises an insert for fabrication of a door light in a door, the door having a pair of interlocking and oppositely disposed door skins forming a cavity therebetween, each door skin comprising a door light opening, the door light opening in each respective door skin being registerably aligned with the opposing door skin, the insert includes a pair of engagement flanges for engagement with the door skins within the cavity, the insert being engageable within the door light opening of each door skin to close the cavity between the door skins to prevent an infill of a foam into the door light opening during fabrication. In some embodiments, the insert further includes a secondary pair of flanges positioned substantially parallel and between the pair of engagement flanges, the secondary flanges are substantially encapsulated in the foam within the cavity during fabrication of the door, and in some of these embodiments, the secondary flanges are equal in length but shorter in length than either of the engagement flanges. In other embodiments, each of the pair of engagement flanges includes an offset engagement surface so that outer interfaces between respective door skins and insert are substantially flush. In some embodiments, the insert is a molded plastic article. In other embodiments, the insert is a metal article formed by a press, the insert including first and second bent portions, and in some of these embodiments, each of the door skins include a bead arranged proximate the respective door light openings and the first and second bent portions of the insert are operatively arranged to matingly engage the respective beads.

The present invention also broadly comprises a door including first and second door skins having first and second door light openings, respectively, the first and second door skins oppositely disposed and arranged to form a cavity therebetween, and the first and second door light openings being registerably aligned and an insert having first and second engagement flanges for engagement with the first and second door skins, respectively, within the cavity, the insert being engageable within the first and second door light openings to close the cavity between the first and second door skins to prevent an infill of a foam into the first and second door light openings during fabrication of the door. In some embodiments, each of the first and second door skins further include at least one horizontal break away strip, at least one vertical break away strip or combinations thereof, the at least one horizontal break away strip and the at least one vertical break away strip are operatively arranged within each of the first and second door light openings.

It is a general object of the present invention to provide a door having a door light at a low cost which is easy to manufacture.

It is another general object of the present invention to minimize the labor and waste created by cutting out a door light from a door after door skins have been assembled and foam insulation has been injected into a cavity formed between the door skins.

It is yet another object of the present invention to minimize associated shipping costs for shipping a door from raw door manufacturers to finished door manufacturers by providing a door having a lower weight.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a first embodiment of a present invention door light insert;

FIG. 2 is a perspective view of the door light insert of FIG. 1 shown during installation between first and second door skins;

FIG. 3 is a cross sectional view of the door light insert of FIG. 1;

FIG. 4 is a cross sectional view of a completed door including the door light insert of FIG. 1 after fabrication;

FIG. 5 is a perspective view of a completed door including the door light insert of FIG. 1;

FIG. 6 is a perspective view of a second embodiment of a present invention door light insert;

FIG. 7 is a perspective view of the door light insert of FIG. 6 shown during installation between first and second door skins;

FIG. 8 is a cross sectional view of the door light insert of FIG. 6;

FIG. 9 is a cross sectional view of a completed door including the door light insert of FIG. 6 after fabrication; and,

FIG. 10 is a front plan view of a door skin including horizontal and vertical break away strips.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “light” is synonymous with terms such as “window”, “opening”, “portal”, “aperture”, “orifice”, “porthole”, etc., and such terms may be used interchangeably as appearing in the specification and claims. Although any methods, devices or materials similar or equivalent to those described herein can be used in the practice or testing of the invention, the preferred methods, devices, and materials are now described.

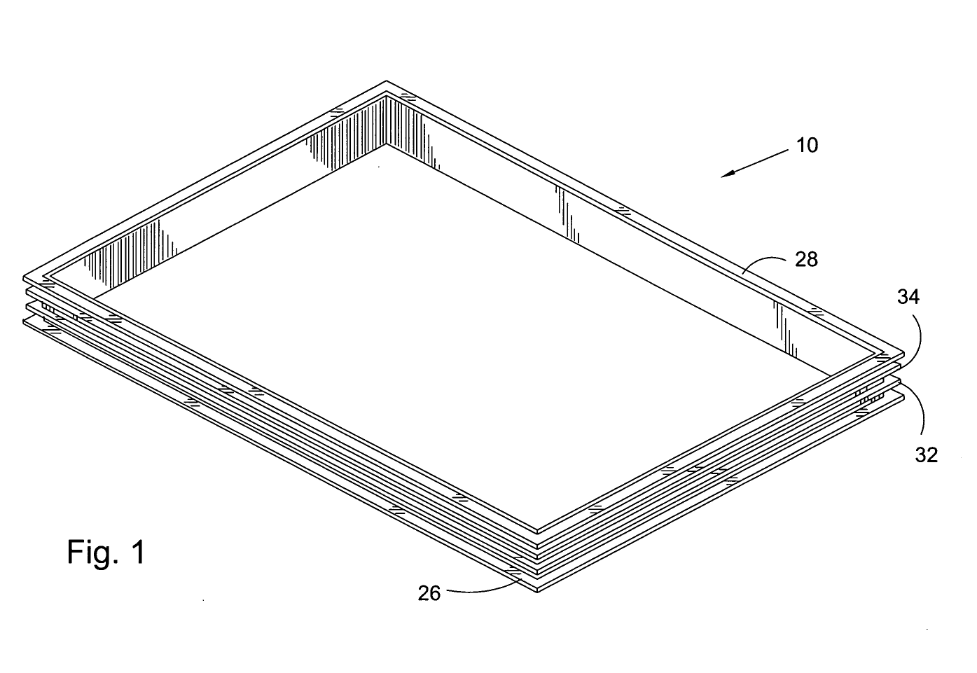

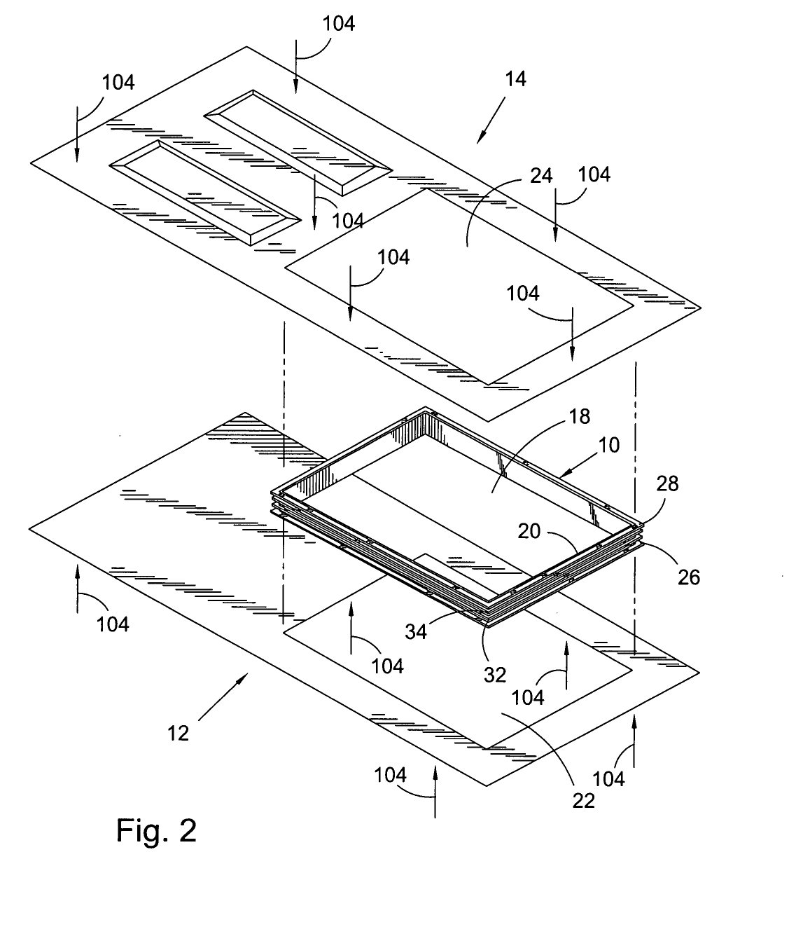

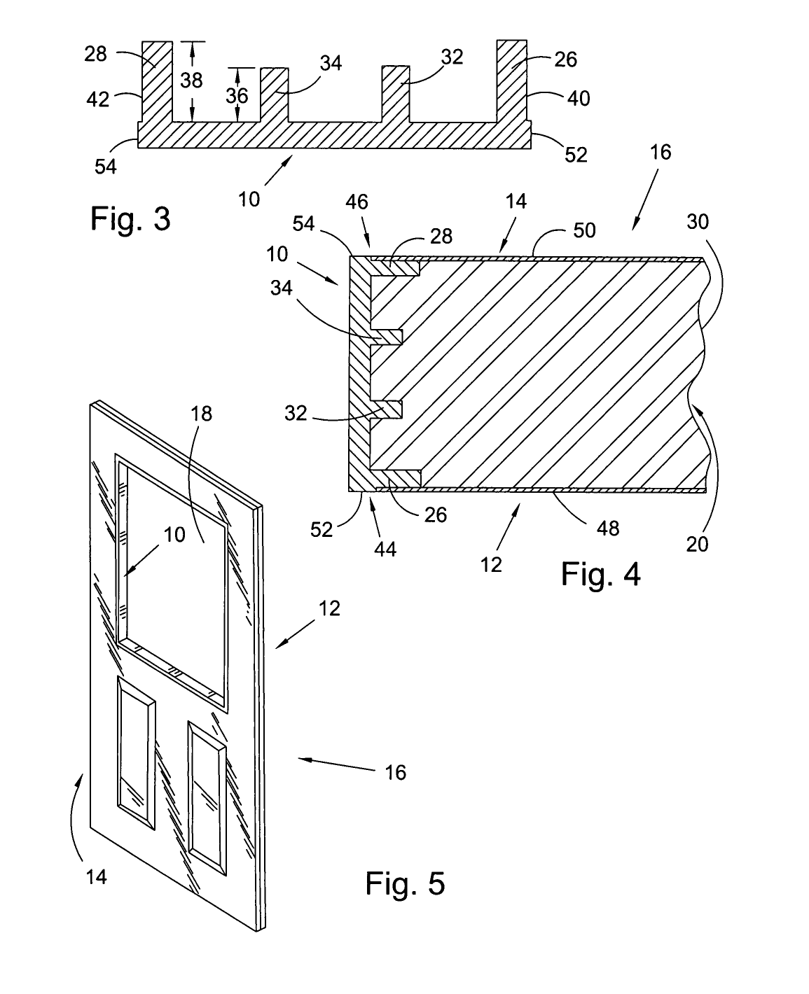

Adverting now to the figures, FIG. 1 shows a perspective view of a first embodiment of present invention door light insert 10, while FIG. 2 shows a perspective view of door light insert 10 during installation between first and second door skins 12 and 14, respectively. FIG. 3 shows a cross sectional view of door light insert 10, FIG. 4 shows a cross sectional view of completed door 16 including door light insert 10 after fabrication and FIG. 5 shows a perspective view of completed door 16 including door light insert 10. The following discussion is best understood in view of FIGS. 1 through 5.

Door light insert 10 is used for fabrication of door light 18 in door 16. Door 16 comprises a pair of interlocking and oppositely disposed door skins 12 and 14 which, when assembled, form cavity 20 therebetween. Door skins 12 and 14 further comprise door light openings 22 and 24, respectively. During assembly of door 16, door light opening 22 is registerably aligned with opposing door light opening 24. In the embodiments shown in FIGS. 1 through 5, insert 10 comprises engagement flanges 26 and 28 for engagement with door skins 12 and 14, respectively, within cavity 20. Insert 10 is engageable within door light openings 22 and 24, and closes cavity 20, i.e., the volume formed between door skins 12 and 14, and prevents infill of foam 30 into door light openings 22 and 24, and hence door light 18, during fabrication.

In some embodiments, insert 10 further comprises secondary flanges 32 and 34 positioned substantially parallel to and between engagement flanges 26 and 28. Secondary flanges 32 and 34 are substantially encapsulated in foam 30 within cavity 20 during fabrication of door 16. In some of these embodiments, secondary flanges 32 and 34 are equal in length but shorter in length than either of engagement flanges 26 or 28. In other words, secondary flanges 32 and 34 have first lengths 36, while engagement flanges 26 and 28 have second lengths 38, and first lengths 36 are less than second lengths 38. In yet other embodiments, engagement flanges 26 and 28 each comprise offset engagement surfaces 40 and 42, respectively, so that outer interfaces 44 and 46 between first and second door skins 12 and 14, respectively, and insert 10 are substantially flush. Outer interfaces 44 and 46 are created by the combination of outer surfaces 48 and 50 of door skins 12 and 14, respectively, and steps 52 and 54 of insert 10, respectively. In the embodiments shown in FIGS. 1 through 5, insert 10 is a molded plastic article. However, as one of ordinary skill in the art will recognize, other materials may also be used, e.g., wood, metal, ceramic or polymers, and such variations are within the spirit and scope of the claimed invention. A second embodiment of a present invention door light insert is discuss in detail infra, wherein the insert is constructed from metal.

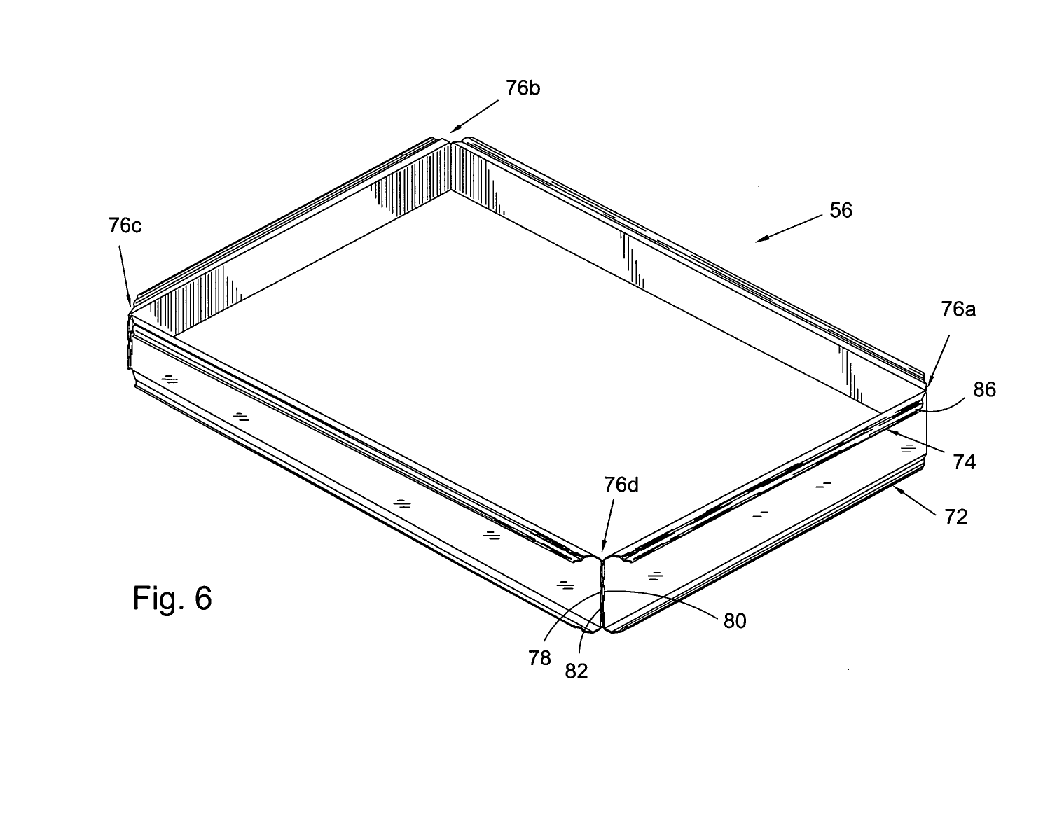

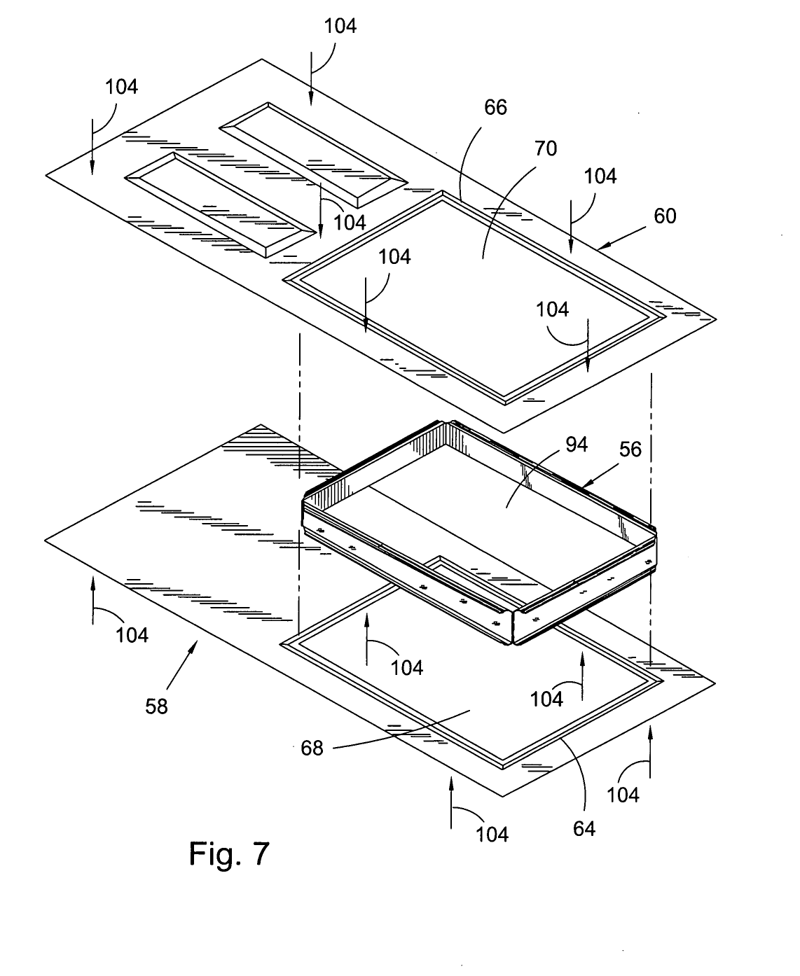

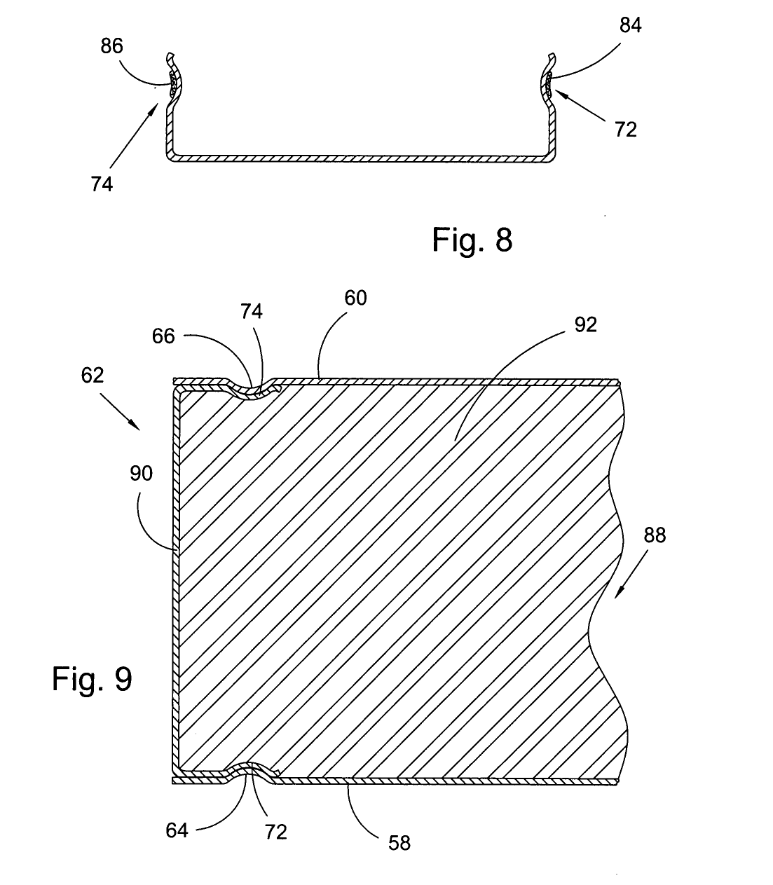

FIG. 6 shows a perspective view of a second embodiment of the present invention, i.e., door light insert 56, while FIG. 7 shows a perspective view of door light insert 56 during installation between first and second door skins 58 and 60, respectively. FIG. 8 shows a cross sectional view of door light insert 56, while FIG. 9 shows a cross sectional view of completed door 62 including door light insert 56 after fabrication. The following discussion is best understood in view of FIGS. 6 through 9.

In the embodiments shown in FIGS. 6 through 9, door skins 58 and 60 comprise beads 64 and 66, respectively, arranged proximate door light openings 68 and 70, respectively. Although beads 64 and 66 are primarily used for the alignment and securing of insert 56, beads 64 and 66 also provide the added benefit of increasing the rigidity of first and second door skins 58 and 60, respectively. This increased rigidity allows for easier handling of door skins during the assembly process. Although the embodiments shown in FIGS. 6 through 9 comprise stamped metal door skins, one of ordinary skill in the art will recognize that other materials of construction for the door skins are also possible, e.g., molded fiberglass, molded polymer or wood, and such variations are within the spirit and scope of the claimed invention. Additionally, in these embodiments, insert 56 is a metal article formed by a press (not shown), for example, a roll press. Insert 56 comprises first and second bent portions 72 and 74, respectively, operatively arranged to matingly engage beads 64 and 66, respectively. After insert 56 exits the press, the areas where corners are required are cut or notched so that insert 56 may be bent to form the desired shape. For example, corners 76a, 76b, 76c and 76d are cut and subsequently bent to form approximately ninety degree angles. First and second ends 78 and 80, respectively, are joined by means generally known in the art, e.g., welding, overlapping, dovetailing or bonding. In the embodiment shown in FIG. 6, first and second ends 78 and 80, respectively, are joined with weld 82. Although in the embodiments shown in FIGS. 6 through 9, bent portions 72 and 74 are arranged to matingly engage beads 64 and 66, respectively, one of ordinary skill in the art will recognize that other means of interfacing insert 56 and door skins 58 and 60 are also possible, e.g., as described supra relative to insert 10, and such variations are within the spirit and scope of the claimed invention. Similarly, although beads 64 and 66 and bent portions 72 and 74 are shown as generally curved shapes, other shapes are also possible, e.g., V-shaped or square shaped, and these variations are also within the spirit and scope of the claimed invention.

In some embodiments, bonding agents 84 and 86 are deposited on bent portions 72 and 74, respectively, as insert 56 exits the press, or are subsequently deposited as secondary operations after forming insert 56. Bonding agents 84 and 86 may for example be an adhesive, a pressure sensitive adhesive, a glue, an epoxy or a weld. Thus, during assembly, bent portion 72 having bonding agent 84 deposited thereon is pressed against bead 64 of first door skin 58 thereby securing insert 56 to first door skin 58. Subsequently, bead 66 of second door skin 60 is pressed against bent portion 74, having bonding agent 86 deposited thereon, thereby securing second door skin 60 to insert 56. One of ordinary skill in the art recognizes that bonding agents 84 and 86 serve a variety of purposes which include but are not limited to: providing bonding strength to hold door skins 58 and 60 and insert 56 together during assembly and thereafter; and, providing a thermal break within the assembly to reduce heat transfer between door skins 58 and 60 and insert 56. Subsequent to assembling door skins 58 and 60 and insert 56, cavity 88, i.e., the volume formed between first and second door skins 58 and 60, respectively, and wall 90 of insert 56, is filled with foam 92. As can be seen in the figures, in these embodiments, wall 90 prevents any inflow of foam 92 within cavity 94, i.e., the opening for a window.

One of ordinary skill in the art recognizes that although not described above, engagement flanges 26 and 28 of insert 10 may also have a bonding agent deposited thereon for purposes of assembly, and such variations are within the spirit and scope of the claimed invention. Additionally, one of ordinary skill in the art will recognize that all embodiments described herein may also be practiced without the presence of bonding agents, and such variations are also within the spirit and scope of the claimed invention.

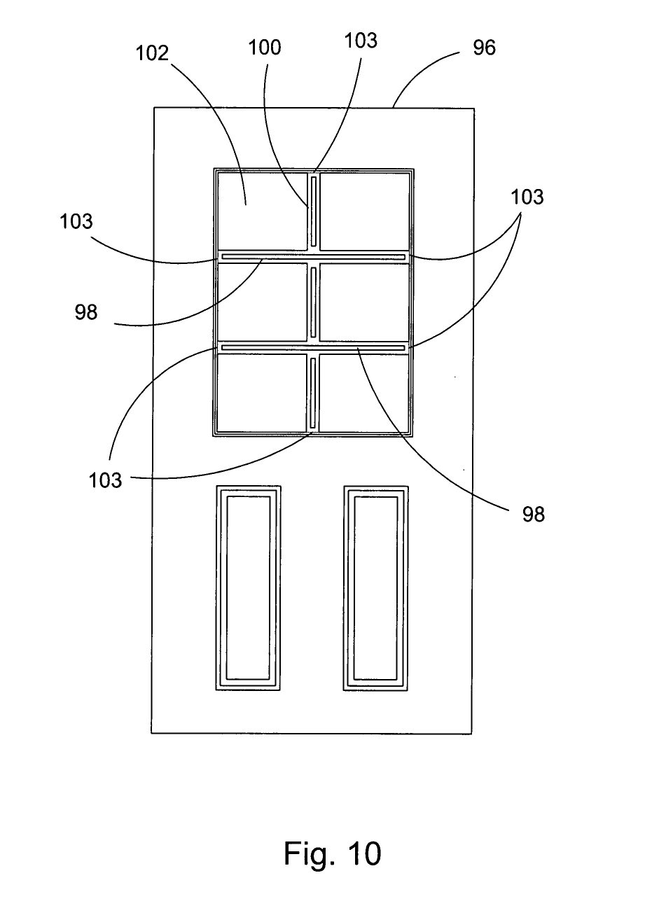

FIG. 10 shows a front plan view of door skin 96 including horizontal and vertical break away strips 98 and 100, respectively. Due to the thickness of the door skins, bending and distortion may occur during the assembly process thereby decreasing the aesthetic quality of the assembled door. Therefore, in some embodiments, door skin 96 includes horizontal and vertical break away strips 98 and 100, respectively, operatively arranged within door light opening 102. Although in the embodiment shown in FIG. 10 door skin 96 includes two horizontal break away strips 98 and one vertical break away strip 100, one of ordinary skill in the art will recognize that other arrangements are also possible, e.g., one horizontal break away strip, one vertical break away strip, one diagonal break away strip, a plurality of horizontal break away strips, a plurality of vertical break away strips, a plurality of diagonal break away strips or combinations thereof, and such variations are within the spirit and scope of the invention as claimed. Subsequent to door assembly, the break away strips may be removed by bending weakened portions 103 until the break away strips separate from the door skin, or alternatively, the break away strips may be left in to provide further structural support during shipping of an assembled door to a manufacturer of finished doors, and in those instances, the break away strips are removed after shipping but prior to the final installation of a window.

The following discussion is best understood in view of FIGS. 1 through 9, and in particular FIGS. 2 and 7. The present invention also broadly comprises a method for fabricating doors, for example doors 16 and 62 having door light insert 10 and 56, respectively. As described supra, door 16 comprises first and second door skins 12 and 14, respectively, having first and second door light openings 22 and 24, respectively, while door 62 comprises first and second door skins 58 and 60, respectively, having first and second door light openings 68 and 70, respectively. A first door skin, e.g., first door skin 12 or 58, is positioned on a press (not shown). Then, an insert, e.g., insert 10 or 56, is positioned in aligned registration with a first door light opening of the first door skin, e.g., first door light opening 22 or 68. Next, a second door skin, e.g., second door skin 14 or 60, is positioned over the insert, wherein a second door light opening, e.g., second door light opening 24 or 70, is in aligned registration with the insert and the first door skin. Then, pressure is applied in the direction of arrows 104 with the press to secure the first and second door skins with the insert. Subesequently, a foam, e.g., foam 30 or 92, is injected into a cavity formed between the first and second door skins and the insert, e.g., cavity 20 or 88.

Depending on the needs and/or requirements of the purchaser of a door assembled by the method described supra, in some embodiments, the method further comprises inserting a window (not shown) within a second cavity formed by the insert, e.g., cavity 18 or 94.

One of ordinary skill in the art will recognize several additional aspects of the present invention, which aspects are within the spirit and scope of the claimed invention. For example, the door skins may also include decorative portions, e.g., embossments, and these portions may be formed during the same stamping operation as the door light openings are formed, or as a prior or subsequent operation. Additionally, the door skins may have decorative portions secured thereto, e.g., raised decorative embellishments. It should also be appreciated that a present invention insert may be sold individually, in combination with door skins or as a part of a completed door having a door light opening and/or a window installed therein. In like fashion, it should be appreciated that, although the present invention inserts described supra have rectangular or square shaped openings, other shapes are also possible, e.g., circular, hemispherical, triangular, polygon or octagon, and such variations are within the spirit and scope of the claimed invention.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A method for fabricating a door having a window, said door comprising first and second door skins having first and second door light openings, respectively, said method comprising the steps of:
a) positioning said first door skin on a first press;
b) positioning an insert in aligned registration with said first door light opening of said first door skin;
c) positioning said second door skin over said insert, wherein said second door light opening is in aligned registration with said insert and said first door skin;
d) applying pressure with said first press to secure said first and second door skins with said insert; and,
e) injecting a foam into a first cavity formed between said first and second door skins and insert.

2. The method of claim 1 further comprising the step of:
f) inserting said window within a second cavity formed by said insert.

3. The method of claim 1, wherein said insert comprises a pair of engagement flanges for aligned registration and engagement with said first and second door skins.

4. The method of claim 3, wherein said insert further comprises a secondary pair of flanges positioned substantially parallel and between said pair of engagement flanges, said secondary pair of flanges are encapsulated by said foam within said cavity during said injection step.

5. The door of claim 4, wherein said secondary flanges are equal in length but shorter in length than either of said engagement flanges.

6. The method of claim 3, wherein each of said pair of engagement flanges comprises an offset engagement surface so that an outer interface between respective first and second door skins and said insert is substantially flush.

7. The method of claim 1, wherein said insert is a molded plastic article.

8. The method of claim 1, wherein said insert is a metal article formed by a second press, said insert comprising first and second bent portions.

9. The method of claim 8, wherein said first and second door skins comprise first and second beads, respectively, arranged proximate said first and second door light openings, respectively, and said first and second bent portions of said insert are operatively arranged to matingly engage said first and second beads, respectively.

10. A door fabricated according to the method of claim 1.

11. An insert for fabrication of a door light in a door, said door comprising a pair of interlocking and oppositely disposed door skins forming a cavity therebetween, each door skin comprising a door light opening, said door light opening in each respective door skin being registerably aligned with said opposing door skin, said insert comprising:
a pair of engagement flanges for engagement with said door skins within said cavity, said insert being engageable within said door light opening of each door skin to close said cavity between said door skins to prevent an infill of a foam into said door light opening during fabrication.

12. The insert of claim 11, wherein said insert further comprises a secondary pair of flanges positioned substantially parallel and between said pair of engagement flanges, said secondary flanges are substantially encapsulated in said foam within said cavity during fabrication of said door.

13. The insert of claim 12, wherein said secondary flanges are equal in length but shorter in length than either of said engagement flanges.

14. The insert of claim 11, wherein each of said pair of engagement flanges comprises an offset engagement surface so that outer interfaces between respective door skins and said insert are substantially flush.

15. The insert of claim 11, wherein said insert is a molded plastic article.

16. The insert of claim 11, wherein said insert is a metal article formed by a press, said insert comprising first and second bent portions.

17. The insert of claim 16, wherein each of said door skins comprise a bead arranged proximate said respective door light openings and said first and second bent portions of said insert are operatively arranged to matingly engage said respective beads.

18. A door comprising:
first and second door skins comprising first and second door light openings, respectively, said first and second door skins oppositely disposed and arranged to form a cavity therebetween, and said first and second door light openings being registerably aligned; and,
an insert comprising first and second engagement flanges for engagement with said first and second door skins, respectively, within said cavity, said insert being engageable within said first and second door light openings to close said cavity between said first and second door skins to prevent an infill of a foam into said first and second door light openings during fabrication of said door.

19. The door of claim 18 wherein each of said first and second door skins further comprise at least one horizontal break away strip, at least one vertical break away strip or combinations thereof, said at least one horizontal break away strip and said at least one vertical break away strip are operatively arranged within each of said first and second door light openings.
